(19) United States
(12) Patent Application Publication
(10) Pub. No.: US 2021/0126803 A1
(43) Pub. Date: Apr. 29, 2021

(54) SINGLE CABLE OPTICAL DATA AND POWER TRANSMISSION SYSTEM

(71) Applicant: Dell Products L.P., Round Rock, TX (US)

(72) Inventors: Victor B. Teeter, Round Rock, TX (US); Shree RamaKrishna Rathinasamy, Round Rock, TX (US); Robert Neal Beard, Austin, TX (US)

(21) Appl. No.: 16/667,587

(22) Filed: Oct. 29, 2019

(51) Int. Cl. H04L 12/10; H04B 10/80

(52) U.S. Cl. CPC H04L 12/10; H04B 10/808

(57) ABSTRACT

A single cable optical data and power transmission system includes a powering device that transmits electrical signal data and power via its powering device port to a first transceiver. The first transceiver then transmits the power via an electrical wire in a cable connected to the first transceiver, while converting the electrical signal data to optical signal data and transmitting the optical signal data via an optical wire in the cable connected to the first transceiver. A second transceiver coupled to the cable receives the optical signal data transmitted over the optical wire in the cable, receives the power transmitted over the electrical wire in the cable, converts the optical signal data to electrical signal data, and transmits the electrical signal data and the power via a powered device port to a powered device.

### BACKGROUND

The present disclosure relates generally to information handling systems, and more particularly to transmitting data optically along with power between information handling systems via a single cable.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices, are sometimes configured to transmit data and power over a single cable to powered devices. For example, Power over Ethernet (PoE) is a term used to describe standard or ad-hoc systems that pass electrical power along with data over a twisted pair Ethernet cable that utilizes electrically conducting copper wires to transmit both data and electrical power, allowing a single cable to provide both a data connection and electric power to powered devices such as PoE wireless access point devices, PoE Internet Protocol (IP) camera devices, PoE Voice over IP (VoIP) phone devices, and/or other PoE powered devices known in the art. Furthermore, the powered devices discussed above continue to require increased data transmission bandwidth, which is a trend that is expected to continue into the future.

While traditional Ethernet cabling such as Cat5 Ethernet cabling, Cat6 Ethernet cabling, and Cat7 Ethernet cabling has been relatively capable of providing the required bandwidth for the current generation of powered devices, PoE powered devices are known to be generally limited in the amount of data they are capable of transmitting, which is due to the capabilities of the Ethernet cables being utilized (e.g., the electrically conducting copper wires utilized in twisted pair Ethernet cabling is generally limited to transmitting up to 1 Gigabit per second (1 Gbps) of data.) As such, in one example, as the high definition video (and audio) streams transmitted by the PoE IP camera devices discussed above continue to require more and more data transmission bandwidth, the limitations of the Ethernet cables discussed above will eventually limit the ability to transmit their associated data at a bandwidth necessary to prevent the degradation of those high definition video (and audio) streams. Furthermore, Ethernet cables are also limited in the distances they can transmit data (e.g., the electrically conducting copper wires utilized in twisted pair Ethernet cabling are generally limited to transmitting data up to 100 meters), resulting in added expenses in situations when data must be transmitted at distances exceeding those capabilities.

Accordingly, it would be desirable to provide a single cable data/power transmission system that addresses the issues discussed above.

### SUMMARY

According to one embodiment, an Information Handling System (IHS) includes a chassis; a port connector that is located on the chassis; a cable coupling that is located on the chassis; a processing system that is coupled to the port connector and the cable coupling; and a memory system that is coupled to the processing system and that includes instructions that, when executed by the processing system, cause the processing system to provide an optical data and power transmission engine that is configured to: receive, via a powering device port that is included on a powering device and that is connected to the port connector, electrical signal data and power transmitted by the powering device; transmit, via an electrical wire coupling that is included in the cable coupling and to an electrical wire that is included in a cable and that is coupled to the electrical wire coupling in the cable coupling, the power; convert the electrical signal data to optical signal data; and transmit, via an optical wire coupling that is included in the cable coupling and to an optical wire that is included in the cable and that is coupled to the cable coupling, the optical signal data.

### BRIEF DESCRIPTION OF THE DRAWINGS

FIG. 1 is a schematic view illustrating an embodiment of an Information Handling System (IHS).

FIG. 2 is a schematic view illustrating an embodiment of a single cable optical data and power transmission system.

FIG. 3 is a schematic view illustrating an embodiment of a transceiver device that may be provided in the single cable optical data and power transmission system of FIG. 2.

FIG. 4 is a schematic view illustrating an embodiment of a transceiver device that may be provided in the single cable optical data and power transmission system of FIG. 2.

FIG. 5A is a schematic view illustrating an embodiment of a cable that may be provided in the single cable optical data and power transmission system of FIG. 2.

FIG. 5B is a schematic view illustrating an embodiment of the cable of FIG. 5A.

FIG. 6 is a flow chart illustrating an embodiment of a method for transmitting data optically along with power in a single cable.

FIG. 7A is a schematic view illustrating an embodiment of the single cable optical data and power transmission system of FIG. 2 operating during the method of FIG. 6.

FIG. 7B is a schematic view illustrating an embodiment of the single cable optical data and power transmission system of FIG. 2 operating during the method of FIG. 6.

FIG. 7C is a schematic view illustrating an embodiment of the single cable optical data and power transmission system of FIG. 2 operating during the method of FIG. 6.

FIG. 7D is a schematic view illustrating an embodiment of the transceiver device of FIG. 3 operating during the method of FIG. 6.

FIG. 7E is a schematic view illustrating an embodiment of the transceiver device of FIG. 3 operating during the method of FIG. 6.

FIG. 7F is a schematic view illustrating an embodiment of the transceiver device of FIG. 3 operating during the method of FIG. 6.

FIG. 7G is a schematic view illustrating an embodiment of the transceiver device of FIG. 4 operating during the method of FIG. 6.

FIG. 7H is a schematic view illustrating an embodiment of the transceiver device of FIG. 4 operating during the method of FIG. 6.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

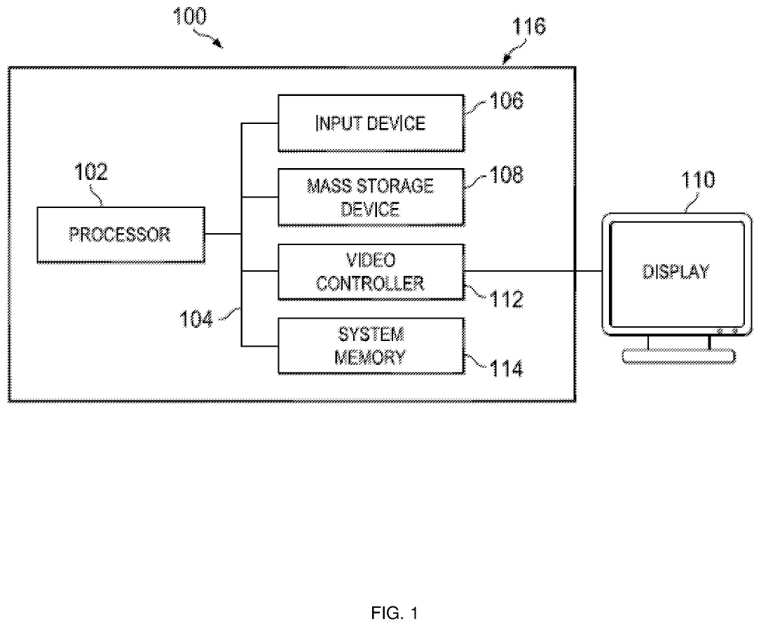

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

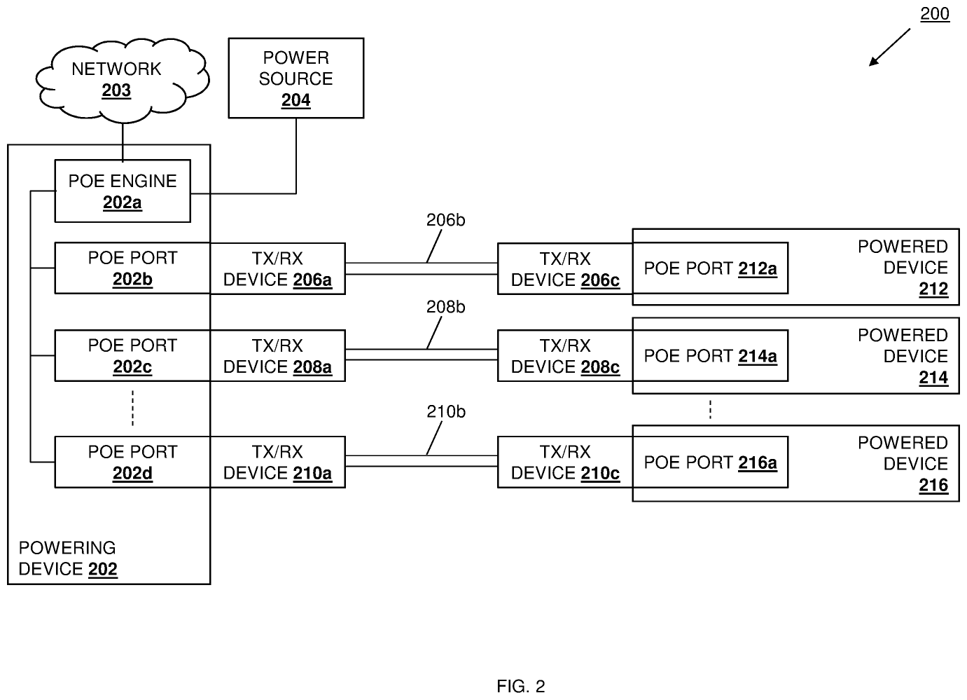

Referring now to FIG. 2, an embodiment of a single cable optical data and power transmission system 200 is illustrated. In the illustrated embodiment, the single cable optical data and power transmission system 200 incudes a powering device 202. In an embodiment, the powering device 202 may be provided by the IHS 100 discussed above with reference to FIG. 1, and/or may include some or all of the components of the IHS 100, and in specific embodiments discussed below is provided by a Power over Ethernet (PoE)-enabled networking/switch device. However, while illustrated and discussed as a PoE-enabled networking/switch device, one of skill in the art in possession of the present disclosure will recognize that powering devices provided in the single cable optical data and power transmission system 200 may include any devices that may be configured to operate similarly as the powering device 202 discussed below while remaining within the scope of the present disclosure as well. For example, FIG. 2 and the examples below describe the powering device 202 as a PoE networking/switch powering device that may include processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a PoE engine 202a that is configured to perform the functionality of the PoE engines and/or powering devices discussed below.

In the illustrated embodiment, the PoE engine 202a is coupled to a network 203 that may be provided by a Local Area Network (LAN), the Internet, combinations thereof, and/or other networks that would be apparent to one of skill in the art in possession of the present disclosure. For example, the powering device 202 may include a communication system (not illustrated, but which may include a Network Interface Controller (NIC) and/or other communication components known in the art) that couples the PoE engine 202a to the network 203. However, while a specific example is provided in which the powering device 202 may receive data via a network, one of skill in the art in possession of the present disclosure will recognize that, in some embodiments, the network 203 may be omitted. For example, in some embodiments, the powering device 202 may be configured to generate data for transmission rather than (or in addition to) receiving data via a network.

In the illustrated embodiment, the PoE engine 202a is coupled to a power source 204. For example, the powering device 202 may include a power subsystem (not illustrated) that provides for the connecting of the powering device 202 to the power source 204 via, for example, a power plug on a power cable that is coupled to a power adapter that is configured to receive power from the power source 204 (via the power cable), convert that power to power that usable by the powering device 202, and provide that power via Power Supply Unit(s) (PSU(s)) and/or other power subsystem components to the PoE engine 202a. However, while a specific power subsystem coupling the PoE engine 202a to the power source 204 has been described, one of skill in the art in possession of the present disclosure will appreciate that the PoE engine 202a may receive power for distribution via ports on the powering device 202 using a variety of techniques that will fall within the scope of the present disclosure as well. As illustrated, the PoE engine 202a in the powering device 202a is coupled to a plurality of PoE ports 202b, 202c, and up to 202d on the powering device 202, each of which is configured to transmit both data and power via a single cable connected to that PoE port. Similarly as described above, the ports on the powering device 202 may be configured to transmit both data and power via a single cable connected to that port using techniques other than PoE while remaining within the scope of the present disclosure as well. However, using the specific example of PoE provided below, each of the PoE ports 202b-202d may include an electrical coupling such as, for example, a copper-based female Ethernet connecter that is configured to transmit data and power via twisted pair electrical/copper wires included in a single Ethernet cable that is coupled to that PoE port.

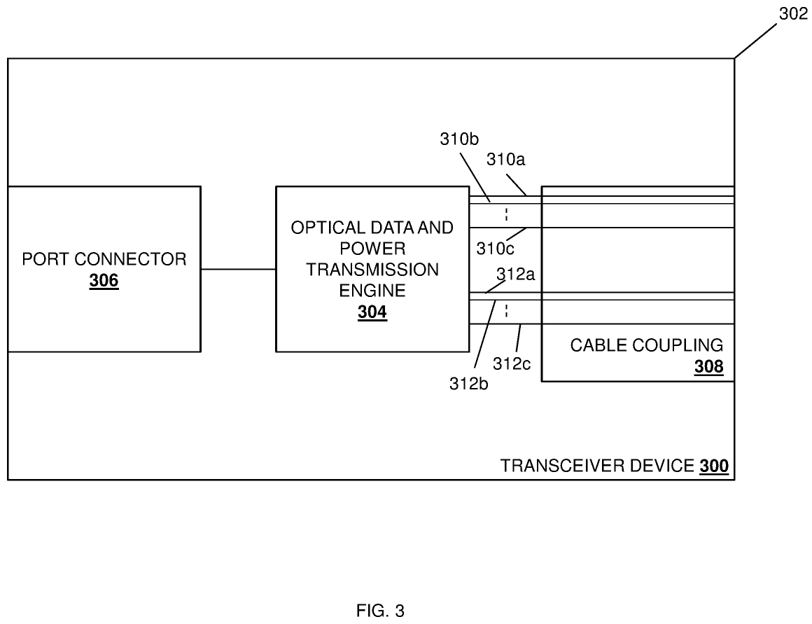

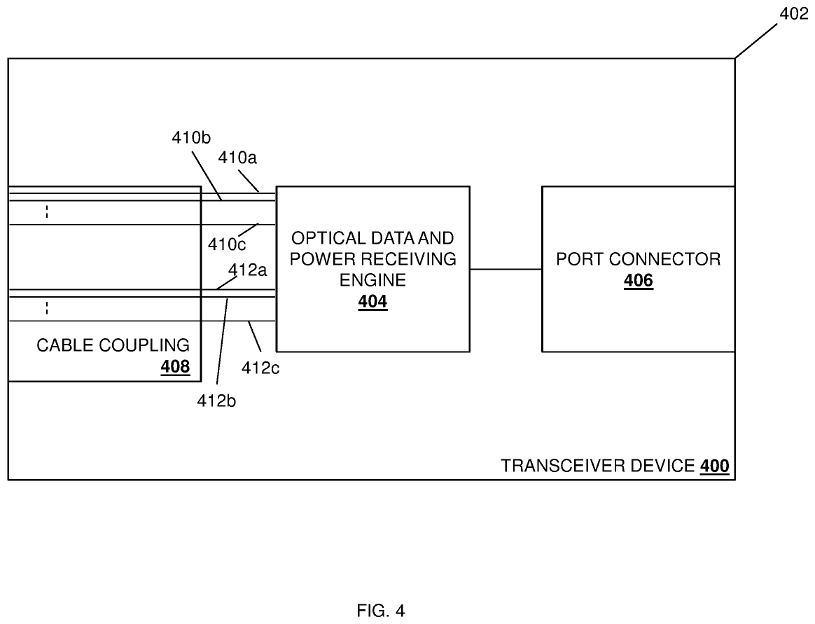

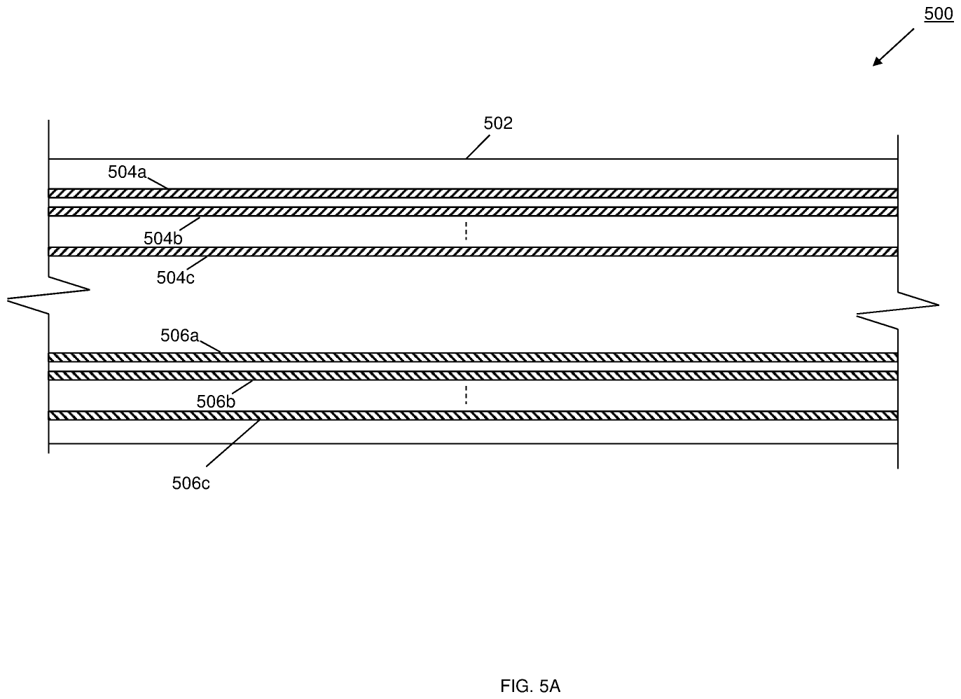

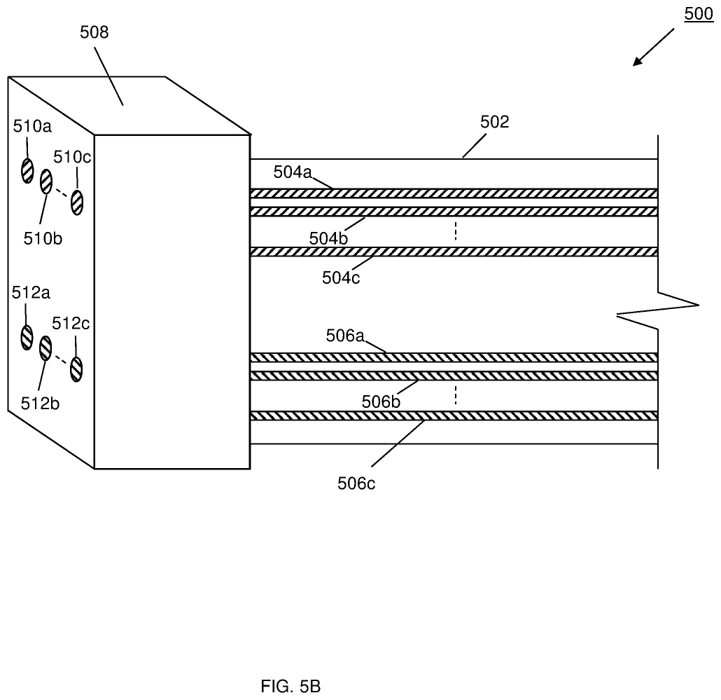

In the illustrated embodiment, each of the PoE ports 202b, 202c, and up to 202d on the powering device 202 is connected to a respective transceiver (“TX/RX” in FIG. 2) device 206a, 208a, and up to 210a, discussed in further detail below with regard to FIG. 3. Furthermore, respective cables 206b, 208b, and up to 210b, discussed in further detail below with regard to FIG. 5, extend between each of the transceiver devices 206a, 208a, and up to 210a, and each of respective transceiver (“TX/RX” in FIG. 2) devices 206c, 208c, and up to 210c, discussed in further detail below with regard to FIG. 4. In an embodiment, any or all of the transceiver devices 206a-210a and 206c-210c may be provided by the IHS 100 discussed above with reference to FIG. 1, and/or may include some or all of the components of the IHS 100. However, while illustrated and discussed as being provided by transceiver devices, one of skill in the art in possession of the present disclosure will recognize that transceiver devices provided in the single cable optical data and power transmission system 200 may include any devices that may be configured to operate similarly as the transceiver devices 206a-210a and 206c-210c discussed below while remaining within the scope of the present disclosure as well.

As discussed in further detail below, in some embodiments the transceiver devices 206a-210a and 206c-210c and the respective cables 206b-210b that couple them together may be separate components that may be coupled together via couplings. However, in other embodiments, the transceiver devices 206a-210a and 206c-210c and the respective cables 206b-210b coupling them together may be integrated components (e.g., with the transceiver devices 206a/206c integrated with the cable 206b, the transceiver devices 208a/208c integrated with the cable 208b, and the transceiver devices 210a/210c integrated with the cable 210b.) Furthermore, while a few specific examples are described herein, one of skill in the art in possession of the present disclosure will appreciate that each transceiver pair and respective cable that provide for the optical data and power transmission between respective ports on powering device/powered device pairs in the present disclosure may be provided in a variety of configurations that will fall within the scope of the present disclosure as well.

In the illustrated embodiment, the transceiver device 206c is illustrated as coupled to a powered device 212 via its PoE port 212a, the transceiver device 208c is illustrated as coupled to a powered device 214 via its PoE port 214a, and the transceiver device 210c is illustrated as coupled to a powered device 216 via its PoE port 216a. In an embodiment, any or all of the powered devices 212-216 may be provided by the IHS 100 discussed above with reference to FIG. 1, and/or may include some or all of the components of the IHS 100, and in specific examples may include PoE wireless access point devices, PoE IP camera devices, PoE VoIP phone devices, and/or other PoE powered devices known in the art. However, while illustrated and discussed as being provided by particular PoE devices, one of skill in the art in possession of the present disclosure will recognize that powered devices provided in the single cable optical data and power transmission system 200 may include any devices that may be configured to operate similarly as the powered devices 212-216 discussed below while remaining within the scope of the present disclosure as well.

Similarly as described above, the ports on the powered devices 212-216 may be configured to receive both data and power via a single cable connected to that port using techniques other than PoE while remaining within the scope of the present disclosure as well. However, using the specific example of PoE provided below, each of the PoE ports 212a-216a may include an electrical coupling such as, for example, a copper-based female Ethernet connecter that is configured to receive data and power via twisted pair electrical/copper wires included in a single Ethernet cable that is coupled to that PoE port. While a specific single cable optical data and power transmission system 200 has been illustrated and described, one of skill in the art in possession of the present disclosure will recognize that the single cable optical data and power transmission system of the present disclosure may include a variety of components and component configurations while remaining within the scope of the present disclosure as well.

Referring now to FIG. 3, an embodiment of a transceiver device 300 is illustrated that may provide any or all of the transceiver devices 206a-210a discussed above with reference to FIG. 2. As such, the transceiver device 300 may be provided by the IHS 100 discussed above with reference to FIG. 1 and/or may include some or all of the components of the IHS 100. Furthermore, while illustrated and discussed as a transceiver device, one of skill in the art in possession of the present disclosure will recognize that the functionality of the transceiver device 300 discussed below may be provided by other devices that are configured to operate similarly as the transceiver device 300 discussed below. In the illustrated embodiment, the transceiver device 300 includes a chassis 302 that houses the components of the transceiver device 300, only some of which are illustrated in FIG. 3. For example, the chassis 302 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an optical data and power transmission engine 304 that is configured to perform the functionality of the optical data and power transmission engines and/or transceiver devices discussed below.

Furthermore, while discussed as having functionality provided by a processing system and a memory system, one of skill in the art in possession of the present disclosure will appreciate that the functionality of the optical data and power transmission engine 304 may be provided by other hardware and/or software configurations while remaining within the scope of the present disclosure as well. For example, some of the inventors of the present disclosure are also inventors on U.S. Pat. No. 10,146,022 filed on Sep. 21, 2017, which describes an electrical/optical data signal converter that may be utilized to provide at least some of the functionality of the optical data and power transmission engine 304 and/or transceiver device 300, and thus the disclosure of U.S. Pat. No. 10,146,022 is incorporated by reference herein in its entirety.

The chassis 302 may also include a port connector 306 that is coupled to the optical data and power transmission engine 304 (e.g., via a coupling between the port connector 306 and the processing system). Continuing with the example provided above, the port connector 306 may be a male Ethernet connector that is configured to receive both data and power transmitted via PoE techniques. However, as discussed above, other coupling hardware may be utilized to connect the transceiver device 300 to powering device ports on powering devices, as well as receive data and power transmitted via a single port on those powering devices, while remaining within the scope of the present disclosure as well. The chassis 302 may also include a cable coupling 308 that is coupled to the optical data and power transmission engine 304 (e.g., via a coupling between the cable coupling 308 and the processing system). As illustrated and discussed in the examples below, the cable coupling 308 may be provided by a female connector that includes respective transceiver optical wire couplings that are configured to receive optical signal data transmitted by the optical data and power transmission engine 304 via a plurality of optical wires 310a, 310b, and up to 310c, and respective transceiver electrical wire couplings that are configured to receive power transmitted by the optical data and power transmission engine 304 via a plurality of electrical wires 312a, 312b, and up to 312c.

For example, the optical wires 310a-310c may be provided by fiber optic wires, while the electrical wires 312a-312c may be provided by copper-based wires, although one of skill in the art in possession of the present disclosure will appreciate that other optical wires and electrical wires will fall within the scope of the present disclosure as well. Furthermore, one of skill in the art in possession of the present disclosure will appreciate that the cable coupling 308 may be provided by other types of connectors (e.g., a male connector), may be an integrated coupling that integrates the transceiver device 300 with the cable described herein, and/or may include a variety of other components and/or component configurations while remaining within the scope of the present disclosure as well. As such, while a specific transceiver device 300 has been illustrated, one of skill in the art in possession of the present disclosure will recognize that transceiver devices (or other devices operating according to the teachings of the present disclosure in a manner similar to that described below for the transceiver device 300) may include a variety of components and/or component configurations for providing conventional transceiver device functionality, as well as the functionality discussed below, while remaining within the scope of the present disclosure as well.

Referring now to FIG. 4, an embodiment of a transceiver device 400 is illustrated that may provide any or all of the transceiver devices 206c-210c discussed above with reference to FIG. 2. As such, the transceiver device 400 may be provided by the IHS 100 discussed above with reference to FIG. 1 and/or may include some or all of the components of the IHS 100. Furthermore, while illustrated and discussed as a transceiver device, one of skill in the art in possession of the present disclosure will recognize that the functionality of the transceiver device 400 discussed below may be provided by other devices that are configured to operate similarly as the transceiver device 400 discussed below. In the illustrated embodiment, the transceiver device 400 includes a chassis 402 that houses the components of the transceiver device 400, only some of which are illustrated in FIG. 4. For example, the chassis 402 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an optical data and power receiving engine 404 that is configured to perform the functionality of the optical data and power receiving engines and/or transceiver devices discussed below.

Furthermore, while discussed as having functionality provided by a processing system and a memory system, one of skill in the art in possession of the present disclosure will appreciate that the functionality of the optical data and power receiving engine 404 may be provided by other hardware and/or software configurations while remaining within the scope of the present disclosure as well. Similarly as discussed above, some of the inventors of the present disclosure are also inventors on U.S. Pat. No. 10,146,022 filed on Sep. 21, 2017, which describes an electrical/optical data signal converter that may be utilized to provide at least some of the functionality of the optical data and power transmission engine 404 and/or transceiver device 400, and thus the disclosure of U.S. Pat. No. 10,146,022 is incorporated by reference herein in its entirety.

The chassis 402 may also include a port connector 406 that is coupled to the optical data and power receiving engine 404 (e.g., via a coupling between the port connector 406 and the processing system). Continuing with the example provided above, the port connector 406 may be a male Ethernet connector that is configured to transmit both data and power via PoE techniques. However, as discussed above, other coupling hardware may be utilized to connect the transceiver device 400 to powered device ports on powered devices, as well as transmit data and power via a single port on those powered devices, while remaining within the scope of the present disclosure as well. The chassis 402 may also include a cable coupling 408 that is coupled to the optical data and power receiving engine 404 (e.g., via a coupling between the cable coupling 408 and the processing system). As illustrated and discussed in the examples below, the cable coupling 408 may be provided by a female connector that includes respective transceiver optical wire couplings that are configured to transmit optical signal data received from respective optical wires in a cable via a plurality of optical wires 410a, 410b, and up to 410c, and respective transceiver electrical wire couplings that are configured to transmit power received from respective electrical wires in a cable via a plurality of electrical wires 412a, 412b, and up to 412c.

For example, the optical wires 410a-410c may be provided by fiber optic wires, while the electrical wires 412a-412c may be provided by copper-based wires, although one of skill in the art in possession of the present disclosure will appreciate that other optical wires and electrical wires will fall within the scope of the present disclosure as well. Furthermore, one of skill in the art in possession of the present disclosure will appreciate that the cable coupling 408 may be provided by other types of connectors (e.g., a male connector), may be an integrated coupling that integrates the transceiver device 400 with the cable described herein, and/or may include a variety of other components and/or component configurations while remaining within the scope of the present disclosure as well. As such, while a specific transceiver device 400 has been illustrated, one of skill in the art in possession of the present disclosure will recognize that transceiver devices (or other devices operating according to the teachings of the present disclosure in a manner similar to that described below for the transceiver device 400) may include a variety of components and/or component configurations for providing conventional transceiver device functionality, as well as the functionality discussed below, while remaining within the scope of the present disclosure as well.

In the embodiments discussed above with reference to FIGS. 3 and 4, as well as in the examples described below, the transceiver devices 300 and 400 are described as separate transceiver devices that can either transmit optical signal data and power over optical wires and electrical wires, respectively, in a cable, or receive optical signal data and power over optical wires and electrical wires, respectively, in the cable. However, the inventors of the present disclosure are in the process of developing a transceiver device that includes both the transmission functionality and the receiving functionality described for the transceiver devices 300 and 400 discussed below, and thus the utilization of such a transceiver device to provide the functionality of each of the transceiver devices 300 and 400 is envisioned as falling within the scope of the present disclosure. As such, a first optical signal data/power transmitting/receiving transceiver may be utilized to provide the transceiver device 300 discussed below on one side of a cable, and a second optical signal data/power transmitting/receiving transceiver may be utilized to provide the transceiver device 400 discussed below on the other side of the cable while remaining within the scope of the present disclosure.

Referring now to FIG. 5A, an embodiment of a cable 500 is illustrated that may provide any or all of the cables 206b, 208b, and up to 210b discussed above with reference to FIG. 2. In the illustrated embodiment, the cable 500 includes a cable body 502 that houses the components of the cable 500, only some of which are illustrated in FIG. 5A. As such, one of skill in the art in possession of the present disclosure will appreciate that the cable body 502 may include a protective outer jacket or sleeve, internal layers that may provide mechanical support and ElectroMagnetic Interference (EMI) shielding, and/or a variety of other conventional cable body components that will fall within the scope of the present disclosure as well. Furthermore, as illustrated in FIG. 5A, the cable body 502 may house a plurality of optical wires 504a, 504b, and up to 504c. In the examples below, the optical wires 504a-504c are provided by fiber optic wires, but one of skill in the art in possession of the present disclosure will appreciate that other optical wires/cables that are configured to transmit optical data signals may fall within the scope of the present disclosure as well.

As also illustrated in FIG. 5A, the cable body 502 may house a plurality of electrical wires 506a, 506b, and up to 506c. In the examples below, the electrical wires 506a-506c are provided by copper-based electrical wires, but one of skill in the art in possession of the present disclosure will appreciate that other electrical wires (e.g., including conductive materials other than or in addition to copper) that are configured to transmit power may fall within the scope of the present disclosure as well. In some embodiments, the electrical wires 506a-506c may be provided by copper-based twisted pair electrical wiring similar to that found in conventional Ethernet cabling. However, as discussed below, in some embodiments the electrical wires 506a-506c may be configured to only transmit power (and not data) and, as such, the cable 500 may be free of twisted pair wiring (i.e., it may only include electrical wiring configured to transmit power). Furthermore, one of skill in the art in possession of the present disclosure will appreciate that embodiments of the cable 500 that do not transmit data via the electrical wires 506a-506c may be free of the shielding layers in the cable body 502 discussed above, as the transmission of data via the optical wires 504a-504c rather than the electrical wires 506a-506c prevents any EMI that would result from transmitting data over twisted pair electrical wiring, and thus allows EMI shielding to be removed from the cable body 502. However, while specific examples have been described, one of skill in the art in possession of the present disclosure will appreciate that the cable 500 may include a variety of components and/or component configurations that will allow for the functionality discussed below while remaining within the scope of the present disclosure.

In some examples, with reference to FIG. 5B, the cable 500 is illustrated including a cable connector 508 on a first end of the cable 500, and one of skill in the art in possession of the present disclosure will appreciate that the cable 500 may also include a similar cable connector on a second end of the cable 500 that is opposite the first end. In the illustrated embodiment, the cable connector 508 includes a plurality of cable connector optical wire couplings 510a, 510b, and up to 510c, each of which is coupled to the respective optical wires 504a, 504b, and up to 504c. Furthermore, the cable connector 508 also includes a plurality of cable connector electrical wire couplings 512a, 512b, and up to 512c, each of which is coupled to the respective electrical wires 506a, 506b, and up to 506c.

In some embodiments, the cable connector 508 may be configured to connect to the cable coupling 308 on the transceiver device 300 to cause the cable connector optical wire couplings 510a, 510b, and up to 510c to couple to the respective optical wires 310a, 310b, and up to 310c in the cable coupling 308, and cause the cable connector electrical wire couplings 512a, 512b, and up to 512c to couple to the respective electrical wires 312a, 312b, and up to 312c in the cable coupling 308. While not illustrated, one of skill in the art in possession of the present disclosure will recognize that the other cable connector (not illustrated) located on the cable 500 opposite the cable connector 508 may be configured to connect to the cable coupling 408 on the transceiver device 400 in a similar manner. However, as discussed above, in other embodiments the cable 500 may be integrated with the transceiver devices 300 and 400 (e.g., rather than attachable and detachable via its cable connectors) while remaining within the scope of the present disclosure as well. Furthermore, while a few specific examples have been described, one of skill in the art in possession of the present disclosure will appreciate that the cable 500 may be provided with the transceiver devices 300 and 400 in a variety of manners that will fall within the scope of the present disclosure as well.

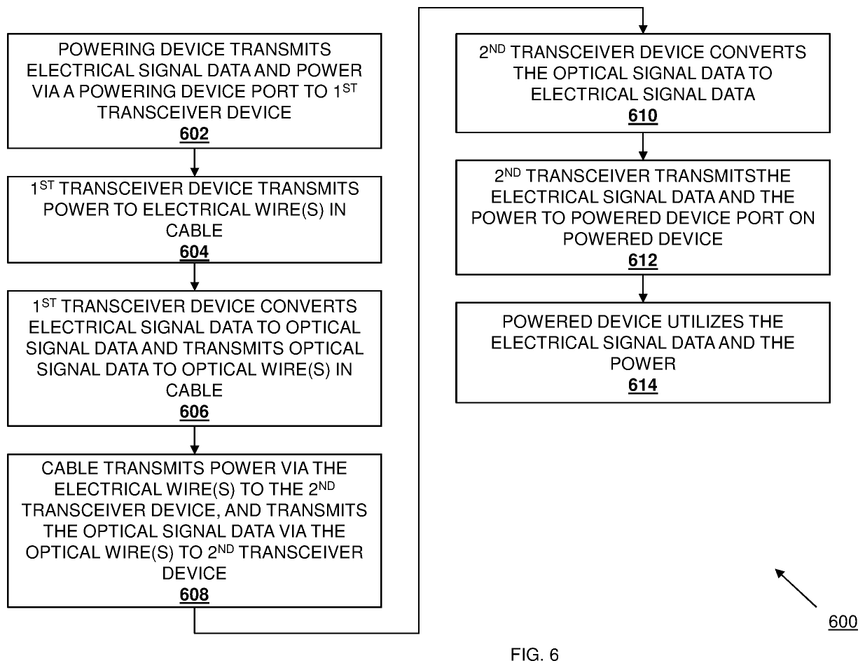

Referring now to FIG. 6, an embodiment of a method 600 for transmitting data optically along with power in a single cable is illustrated. As discussed below, the systems and methods of the present disclosure provide for the transmission of power on electrical wiring in a cable along with the transmission of data optically within that same cable. For example, a powering device may transmit power and electrical signal data via one of its powering device ports to a first transceiver. The first transceiver that is coupled to a cable may then transmit the received power via electrical wire(s) in the cable, while converting the electrical signal data to optical signal data, and transmitting the optical signal data via optical wire(s) in the cable. A second transceiver coupled to the cable and a powered device port on a powered device may then receive the power and the optical signal data transmitted via the cable, convert the optical signal data to electrical signal data, and provide the power and electrical signal data to the powered device port. The powered device may then utilize the power and electrical signal data.

As discussed below, the systems and methods of the present disclosure provide for data/power transmission in a single cable with higher data transmission speeds, longer cable lengths, reduced electrical component complexity in the cable (e.g., without the need for twisted pair electrical wiring and corresponding cable body shielding layers), and/or other benefits that will be apparent to one of skill in the art in possession of the present disclosure. In a specific example, conventional electrical wires such as twisted pair electrical wires are generally limited to 10 Gbps data transmission speeds, while optical wires such as fiber optic wires are expected to reach 100 Gbps data transmission speeds and beyond. Furthermore, cables including conventional electrical wires such as twisted pair electrical wires are generally limited to lengths of about 100 meters, which is much less than the cable lengths available via optical wires such as fiber optic wires (which are capable of transmitting data much further than electrical wires with the same data signal degredation), and the single cable optical data and power transmission system of the present disclosure is expected to increase cable lengths up to the limits of optical wire data transmission capabilities and electrical wire power transmission capabilities.

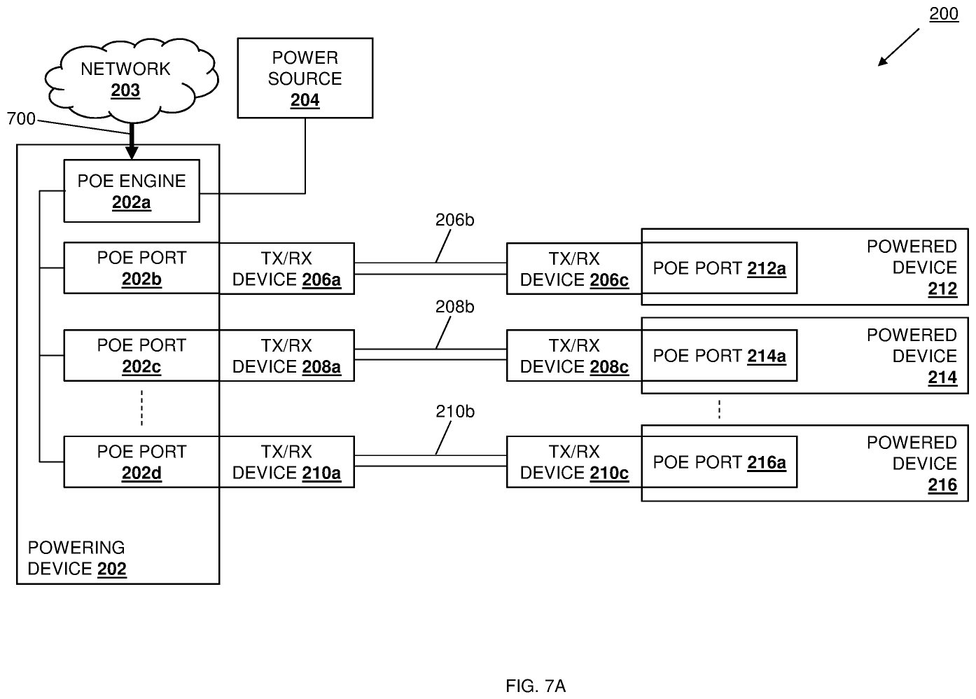

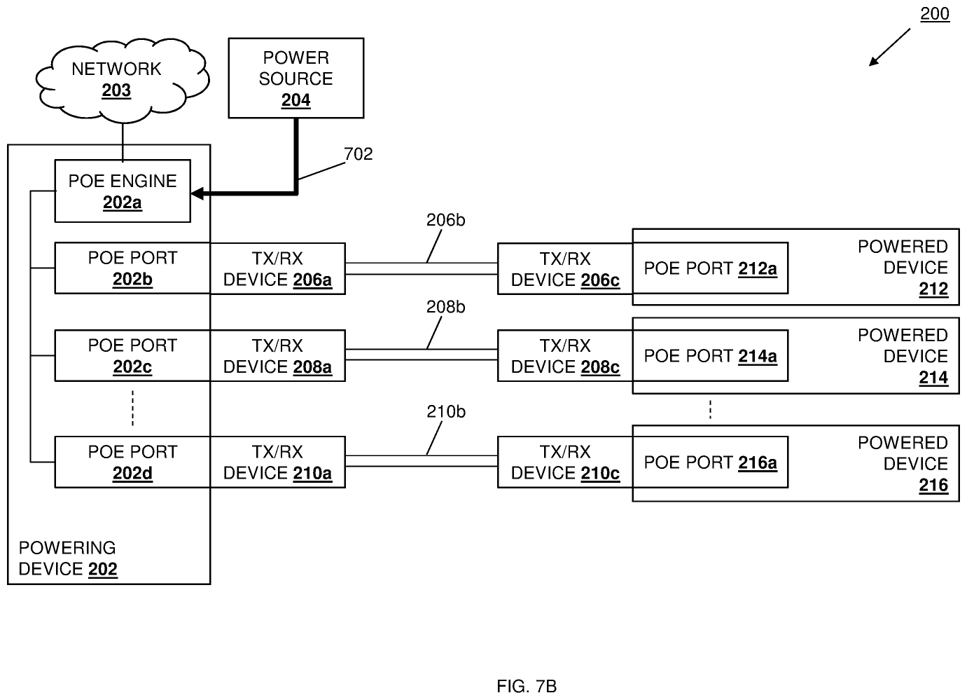

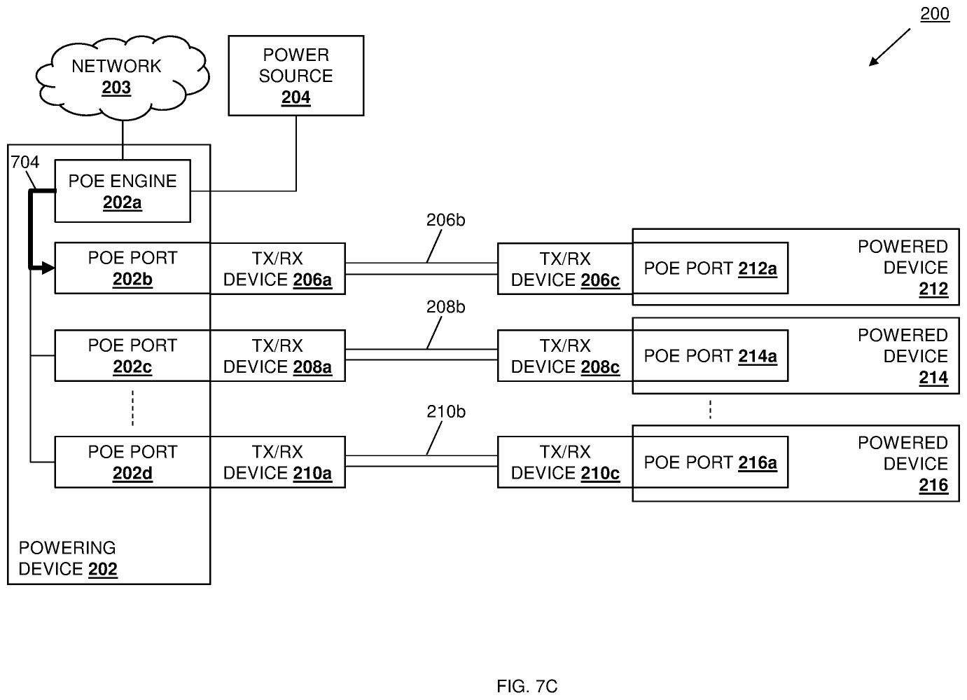

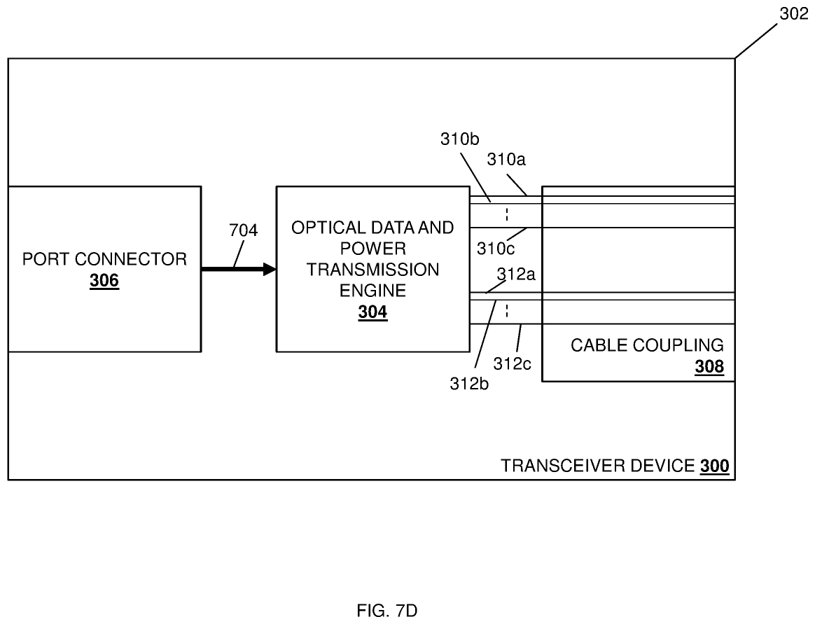

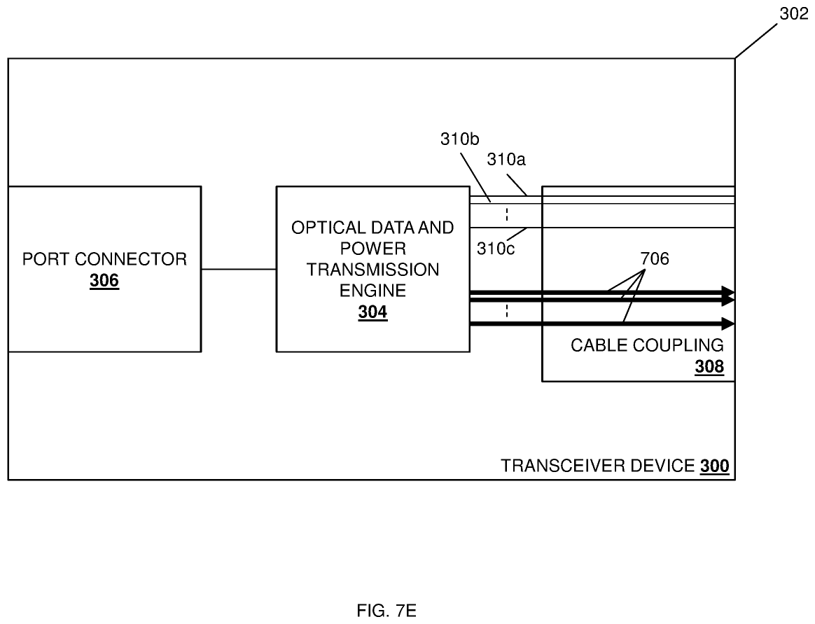

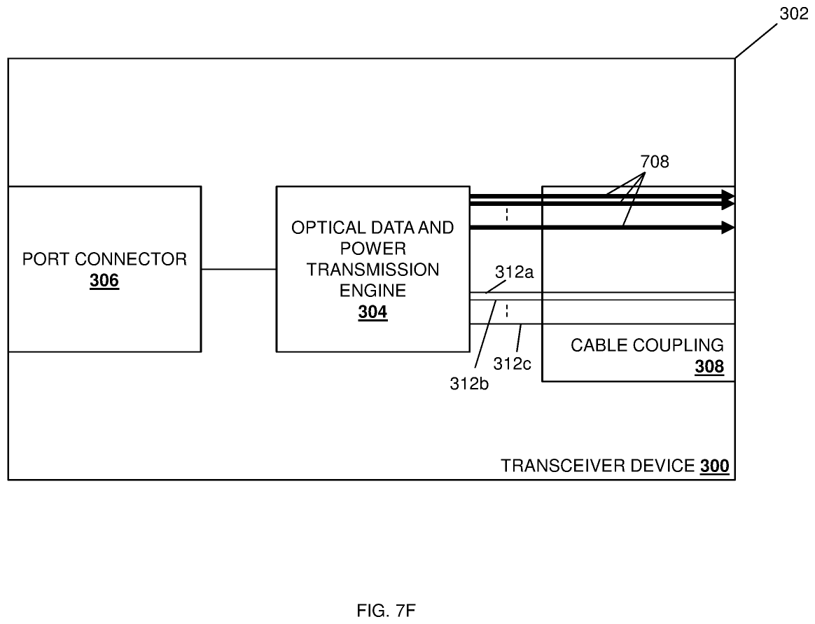

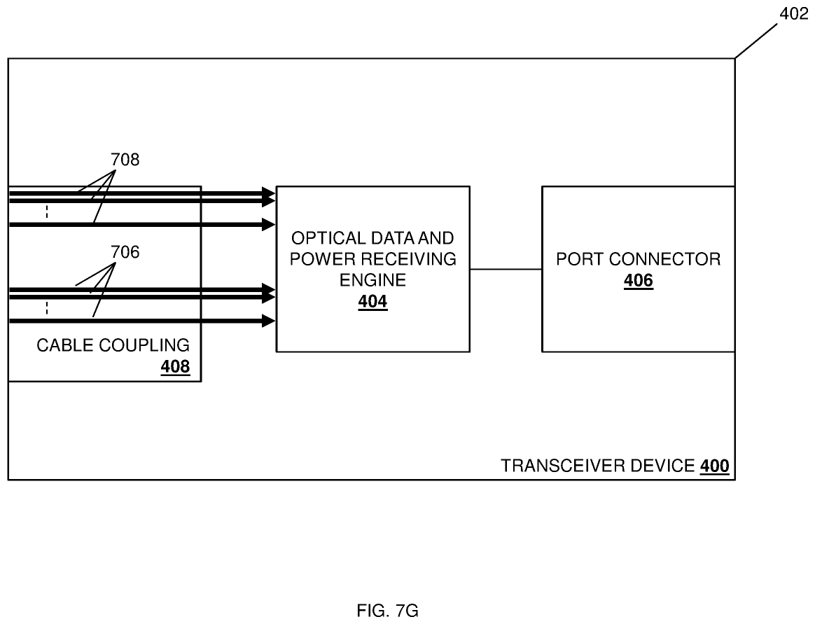

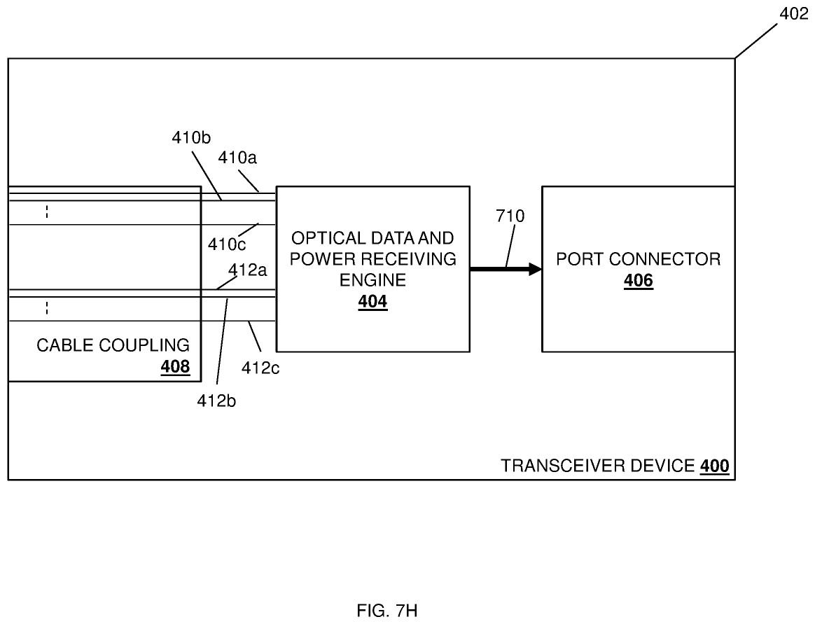

The method 600 begins at block 602 where a powering device transmits electrical signal data and power via a powering device port to a first transceiver device. With reference to FIG. 7A, in an embodiment of block 602, the PoE engine 202a in the powering device 202a may receive data 700 via the network 203 that is destined for transmission to (or through) the powered device 212 in the examples below. However, as discussed above, in other embodiments, the powering device 202 may generate the data for transmission to the powered device 212 while remaining within the scope of the present disclosure as well. Furthermore, while described as being utilized to transmit data and power to the powered device 212, one of skill in the art in possession of the present disclosure will recognize that the systems and methods will allow data and power to be transmitted to the powered devices 214 and up to 216 in substantially the same manner as described below while remaining within the scope of the present disclosure as well.

With reference to FIG. 7B, at block 602, the PoE engine 202a may receive power 702 from the power source 204, and may operate to provide the data 700 as electrical signal data (e.g., a data signal that is configured to be transmitted via electrical wiring) and at least some amount of the power 702 to the PoE port 202b. For example, at block 602, the PoE engine 202a may utilize PoE techniques for providing both power and electrical signal data to the PoE port 202b provided by an Ethernet port. In a specific example, the amount of the power 702 provided by the PoE engine 202a to the PoE port 202b may be up to 99 watts for conventional PoE devices, although one of skill in the art in possession of the present disclosure will appreciate that other power amounts will fall within the scope of the present disclosure as well. Furthermore, one of skill in the art in possession of the present disclosure will recognize that other techniques for providing power and electrical signal data to a single port will fall within the scope of the present disclosure as well. As such, with reference to FIG. 7C, at block 602 power and electrical signal data 704 may be provided to the PoE port 202b by the PoE engine 202a, and will be transmitted via that PoE port 202b to the port connector 206 on the transceiver device 206a/300.

The method 600 then proceeds to block 604 where the first transceiver device transmits the power to electrical wire(s) in a cable. As illustrated in FIG. 7D, in an embodiment of block 604, the optical data and power transmission engine 304 in the transceiver device 206a/300 may receive the power and electrical signal data 704 from the port connector 306. As illustrated in FIG. 7E, the optical data and power transmission engine 304 in the transceiver device 206a/300 may then operate to transmit power 706 received via the port connector 306 to the electrical wires 312a, 312b, and up to 312c such that that power is provided to the cable coupling 308. In some embodiments, the optical data and power transmission engine 304 in the transceiver device 206a/300 may include hardware and/or software that is configured to separate the power received via the port connector 306 along with the electrical signal data such that that power may be transmitted through the electrical wires 312a, 312b, and up to 312c to the cable coupling 308. However, in other embodiments, the power may be received at the port connector 306 in a manner that allows the optical data and power transmission engine 304 in the transceiver device 206a/300 to route that power to the electrical wires 312a, 312b, and up to 312c in any manner that provides that power to the cable coupling 308. While a few examples have been provided, one of skill in the art in possession of the present disclosure will recognize that the power received along with electrical signal data at the port connector 306 on the transceiver device 206a/300 may be provided via the electrical wire(s) 312a-312c to the cable coupling 308 in a variety of manners that will fall within the scope of the present disclosure as well.

The method 600 then proceeds to block 606 where the first transceiver device converts the electrical signal data to optical signal data, and transmits the optical signal data to optical wire(s) in the cable. As illustrated in FIG. 7F, in an embodiment of block 606, the optical data and power transmission engine 304 in the transceiver device 206a/300 may operate to convert the electrical signal data received via the port connector 306 to optical signal data 708, and provide that optical signal data 708 to the optical wires 310a, 310b, and up to 310c such that that the optical signal data 708 is provided to the cable coupling 308. In some embodiments, the optical data and power transmission engine 304 in the transceiver device 206a/300 may include hardware and/or software that is configured to separate the electrical signal data received via the port connector 306 along with the power such that that electrical signal data may be converted to optical signal data that may be transmitted through the optical wires 310a, 310b, and up to 310c to the cable coupling 308. However, in other embodiments, the electrical signal data may be received at the port connector 306 in a manner that allows the optical data and power transmission engine 304 in the transceiver device 206a/300 to convert that electrical signal data to optical signal data and route that optical signal data to the optical wires 310a, 310b, and up to 310c in any manner that provides that optical signal data to the cable coupling 308. While a few examples have been provided, one of skill in the art in possession of the present disclosure will recognize that the electrical signal data received along with power at the port connector 306 on the transceiver device 206a/300 may be converted to optical signal data that is then provided via the optical wire(s) 310a-310c to the cable coupling 308 in a variety of manners that will fall within the scope of the present disclosure as well.

The method 600 then proceeds to block 608 where the cable transmits the power via the electrical wire(s) to a second transceiver device, and transmits the optical signal data via the optical wire(s) to the second transceiver device. In an embodiment, at block 608, the cable 500 will operate to transmit the power 706 provided to the cable coupling 308 on the transceiver device 206a/300 via its electrical wires 506a, 506b, and up to 506c, and transmit the optical signal data 708 provided to the cable coupling 308 on the transceiver device 206a/300 via its optical wires 504a, 504b, and up to 504c. In some examples, with reference to the embodiment of the cable 500 illustrated in FIG. 5B that includes the cable connector 508 that connects to the cable coupling 308, the power 706 provided to the cable coupling 308 on the transceiver device 206a/300 is transmitted to the electrical wires 506a-506c in the cable 500 via the cable connector electrical wire couplings 512a-512c, while the optical signal data 708 provided to the cable coupling 308 on the transceiver device 206a/300 is transmitted to the optical wires 504a-504c in the cable 500 via the cable connector optical wire couplings 510a-510c.

However, in other examples, the cable 500 may be integrated with the transceiver device 206a/300 such that the electrical wires 506a-506c in the cable 500 extend from the electrical wires 312a-312c in the transceiver device 206a/300 and, as such, the transmitting of the power via the electrical wires 312a-312c by the optical data and power transmission engine 304 in the transceiver device 206a/300 operates to transmit that power via the electrical wires 506a/506c in the cable 500. Similarly, the cable 500 may be integrated with the transceiver device 206a/300 such that the optical wires 504a-504c in the cable 500 extend from the optical wires 310a-310c in the transceiver device 206a/300 and, as such, the transmitting of the optical signal data via the optical wires 310a-310c by the optical data and power transmission engine 304 in the transceiver device 206a/300 operates to transmit that optical signal data via the optical wires 504a-504c in the cable 500. However, as discussed above, while specific examples are described, the transceiver 300/cable 500 coupling may be provided in a variety of manners that allow the optical signal data and power to be transmitted via the transceiver device 300 and through the cable 500 while remaining within the scope of the present disclosure as well. As will be appreciated by one of skill in the art in possession of the present disclosure, the optical wires 504a-504c in the cable 500 that may include fiber optic wires that provide for the transmittal of optical signal data at multiples of the speed that electrical signal data is conventionally transmitted along with power over electrical wires such as twisted pair electrical wires, and those fiber optic wires are expected to reach data transmission speeds that are 10 times or more higher than available on conventional twisted pair electrical wires.

The method 600 then proceeds to block 610 where the second transceiver device converts the optical signal data to electrical signal data. In an embodiment, at block 610, the optical signal data and power transmitted via the cable 500 is provided to the transceiver device 206c/400. In some examples, with reference to the embodiment of the cable 500 illustrated in FIG. 5B that includes the cable connector 508 that connects to the cable coupling 308, the transceiver device 206c/400 may be coupled to similar cable connector on the cable 500, and the power 706 transmitted via the electrical wires 506a-506c in the cable 500 may be provided via the cable connector electrical wire couplings on that cable connector to the cable coupling 408, while the optical signal data 708 transmitted via the optical wires 504a-504c in the cable 500 may be provided via the cable connector optical wire couplings on that cable connector to the cable coupling 408.

However, in other examples, the cable 500 may be integrated with the transceiver device 206c/400 such that the electrical wires 412a-412c in the cable coupling 408 extend from the electrical wires 506a-506c in the cable 500 and, as such, the transmitting of the power via the electrical wires 506a/506c in the cable 500 operates to transmit that power via the electrical wires 412a-412c in the cable coupling 408. Similarly, the cable 500 may be integrated with the transceiver device 206c/400 such that the optical wires 410a-410c in the cable coupling 408 extends from the optical wires 504a-504c in the cable 500 and, as such, the transmitting of the optical signal data via the optical wires 504a/504c in the cable 500 operates to transmit that optical signal data via the optical wires 410a-410c in the cable coupling 408. However, as discussed above, while specific examples are described, the transceiver 400/cable 500 coupling may be provided in a variety of manners that allow the optical signal data and power to be received via the transceiver device 400 and through the cable 500 while remaining within the scope of the present disclosure as well.

As such, as illustrated in FIG. 7G, the optical data and power receiving engine 404 in the transceiver device 206c/400 may receive the power 706 via the electrical wires 412a-412c in the cable coupling 408, and may receive the optical signal data 708 via the optical wires 410a-410c in the cable coupling 408. In an embodiment, in response to receiving the optical signal data 708, the optical data and power receiving engine 404 in the transceiver device 206c/400 may operate to convert the optical signal data to electrical signal data. In some embodiments, the optical data and power receiving engine 404 in the transceiver device 206c/400 may include hardware and/or software that is configured to convert optical signal data to electrical signal data that may be transmitted through electrical wires along with power. However, while a specific example has been provided, one of skill in the art in possession of the present disclosure will recognize that the optical signal data may be converted to electrical signal data in a variety of manners that will fall within the scope of the present disclosure as well.

The method 600 then proceeds to block 612 where the second transceiver device transmits the electrical signal data and the power to a powered device port on a powered device. As illustrated in FIG. 7H, in an embodiment of block 612, the optical data and power receiving engine 404 in the transceiver device 206c/400 operates to transmit the power (received via the electrical wires 412a-412c in the cable coupling 408) and the electrical signal data (converted from the optical signal data received via the optical wires 410a-410c in the cable coupling 408) as electrical signal data/power 710 to the port connector 406 on the transceiver device 206c/400, which results in the electrical signal data/power 710 being provided through the PoE port 212a on the powered device 212 and to the powered device 212. As discussed above, in some examples in which the port connector 406 is a male Ethernet port connector configured to transmit power and electrical signal data using PoE techniques, and the PoE port 212a on the powered device 212 is configured to receive power and electrical signal data using PoE techniques, those techniques may be utilized to transfer the power and electrical signal data 710 from the transceiver device 206c/400 to the PoE port 212a. However, as discussed above, other techniques for transmitting power and electrical signal data will fall within the scope of the present disclosure as well.

The method 600 then proceeds to block 614 where the powered device utilizes the electrical signal data and the power. In an embodiment, at block 614, the powered device 212 may operate to utilize the power received in the power/electrical signal data 710 to power one or more powered device components in the powered device 212, transfer power to other devices connected to the powered device 212, and/or in a variety of power utilizations manners that would be apparent to one of skill in the art in possession of the present disclosure. Furthermore, at block 614, the powered device 212 may operate to utilize the data received in the power/electrical signal data 710, transfer that data to other devices connected to the powered device 212, and/or in a variety of data utilizations manners that would be apparent to one of skill in the art in possession of the present disclosure.

Thus, systems and methods have been described that provide for the transmission of power on electrical wiring in a cable along with the transmission of data optically within that same cable. For example, a PoE powering device may transmit power and electrical signal data via one of its PoE powering device ports to a first transceiver. The first transceiver that is coupled to a cable may then transmit the received power via electrical wire(s) in the cable, while converting the electrical signal data to optical signal data, and transmitting the optical signal data via optical wire(s) in the cable. A second transceiver coupled to the cable and a PoE powered device port on a Poe powered device may then receive the power and the optical signal data transmitted via the cable, convert the optical signal data to electrical signal data, and provide the power and electrical signal data to a PoE powered device port on a PoE powered device. The PoE powered device may then utilize the power and electrical signal data. As such, PoE power and data transmission may be provided in a single cable with higher data transmission speeds, longer cable lengths, reduced electrical components complexity in the cable (e.g., without the need for twisted pair electrical wiring and corresponding cable body shielding layers), and/or other benefits that will be apparent to one of skill in the art in possession of the present disclosure.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A single cable optical data and power transmission system, comprising:
a powering device that is configured to transmit electrical signal data and power via a powering device port on the powering device, wherein the powering device is a networking device that is configured to transmit the electrical signal data and the power via the powering device port using Power over Ethernet (PoE) technology, and wherein the powering device port includes a first Ethernet connector that is configured to transmit data and power via twisted pair wires included in an Ethernet cable;
a first transceiver that is coupled to the first Ethernet connector and that is configured to:
receive the electrical signal data and power transmitted via the first Ethernet connector, wherein the power is received according to a PoE classification of a first transceiver port connector that is connected to the powering device port, and wherein a first portion of the power received is used to power the first transceiver;
transmit, using the first portion of the power, a second portion of the power via a first transceiver electrical wire coupling; and
convert, using the first portion of the power, the electrical signal data to optical signal data and transmit the optical signal data via a first transceiver optical wire coupling;
a cable that is coupled to the first transceiver and that includes:
an optical wire that is coupled to the first transceiver optical wire coupling and that is configured to transmit the optical signal data received from the first transceiver optical wire coupling; and
an electrical wire that is coupled to the first transceiver electrical wire coupling and that is configured to transmit the second portion of the power received from the first transceiver electrical wire coupling;
a second transceiver that is coupled to the cable and that is configured to:
receive the optical signal data transmitted over the transceiver optical wire in the cable at a second transceiver optical wire coupling;
receive the second portion of the power transmitted over the transceiver electrical wire in the cable at a second transceiver electrical wire coupling;
convert the optical signal data to electrical signal data; and
transmit the electrical signal data and the second portion of the power; and
a powered device that includes a powered device port that is coupled to the second transceiver, that is configured to receive the electrical signal data and the second portion of power transmitted by the second transceiver, and that includes a second Ethernet connector that is configured to receive data and the second portion of the power via twisted pair wires included in an Ethernet cable.

2. The system of claim 1, wherein the first transceiver includes a first wherein the second transceiver includes a second transceiver port connector that is connected to the powered device port.

3. The system of claim 1, wherein the first transceiver includes a first transceiver cable coupling port that is connected to a first cable connector included on the cable, and wherein the second transceiver includes a second transceiver cable coupling port that is connected to a second cable connector included on the cable, wherein the first transceiver cable coupling is configured to attach and detach from the first cable connector, and wherein the second cable coupling is configured to attach and detach from the second cable connector.

4. The system of claim 1, wherein the first transceiver electrical wire coupling is configured to transmit the second portion of the power to the electrical wire in the cable that includes copper, and wherein the first transceiver optical wire coupling is configured to transmit the optical signal data to the optical wire in the cable that includes a fiber optic wire.

5. (canceled)

6. The system of claim 1, wherein first transceiver device is configured to transmit the optical signal data via the first transceiver optical wire coupling and over the optical wire in the cable at data transmission speeds in excess of 100 Gigabits per second (Gbps).

7. The system of claim 1, wherein the electrical wire in the cable is free of twisted electrical wire pairs, and wherein the cable is free of ElectroMagnetic Interference (EMI) shielding.

8. An Information Handling System (IHS), comprising:
a chassis;
a port connector that is located on the chassis and that includes Power over Ethernet (PoE) classification circuitry;
a cable coupling that is located on the chassis;
a processing system that is coupled to the port connector and the cable coupling; and
a memory system that is coupled to the processing system and that includes instructions that, when executed by the processing system, cause the processing system to provide an optical data and power transmission engine that is configured to:
receive, via a powering device port that is included on a powering device, that is connected to the port connector, and that includes an Ethernet connector that is configured to transmit data and power via twisted pair wires included in an Ethernet cable, electrical signal data and power transmitted by the powering device,
wherein the powering device is provided by a networking device that is configured to transmit the electrical signal data and the power via the powering device port using Power over Ethernet (PoE) technology,
wherein the power is received according to a PoE classification of the port connector using the PoE classification circuitry that is connected to the powering device port, and
wherein a first portion of the power received is used to power the cable coupling, the processing system, and the memory system;
transmit, using the first portion of the power and via an electrical wire coupling that is included in the cable coupling and to an electrical wire that is included in a cable and that is coupled to the electrical wire coupling in the cable coupling, a second portion of the power;
convert, using the first portion of the power, the electrical signal data to optical signal data; and
transmit, using the first portion of the power and via an optical wire coupling that is included in the cable coupling and to an optical wire that is included in the cable and that is coupled to the cable coupling, the optical signal data.

9. (canceled)

10. The IHS of claim 8, wherein the cable coupling includes:
a cable coupling port that is connected to a cable connector included on the cable, wherein the cable coupling port is configured to attach and detach from the cable connector.

11. The IHS of claim 8, wherein the electrical wire coupling is configured to transmit the second portion of power to the electrical wire in the cable that includes copper, and wherein the optical wire coupling is configured to transmit the optical signal data to the optical wire in the cable that includes a fiber optic wire.

12. (canceled)

13. The IHS of claim 8, wherein optical data and power transmission engine is configured to:
transmit the optical signal data via the optical wire coupling and over the optical wire in the cable at data transmission speeds in excess of 100 Gigabits per second (Gbps).

14. A method for transmitting optical data and power via a single cable, comprising:
receiving, by a transceiver device via a powering device port that is included on a powering device, that is connected to the transceiver device, and that includes an Ethernet connector that is configured to transmit data and power via twisted pair wires included in an Ethernet cable, electrical signal data and power transmitted by the powering device,
wherein the powering device is provided by a networking device that is configured to transmit the electrical signal data and the power via the powering device port using Power over Ethernet (PoE) technology,
wherein the power is received according to a PoE classification of an Ethernet port connector on the transceiver device that is connected to the powering device port, and
wherein a first portion of the power received is used to power the transceiver device;
transmitting, by the transceiver device using the first portion of the power and via an electrical wire coupling that is included in the transceiver device and to an electrical wire that is included in a cable and that is coupled to the transceiver device, a second portion of the power;
converting, by the transceiver device using the first portion of the power, the electrical signal data to optical signal data; and
transmitting, by the transceiver device using the first portion of the power and via an optical wire coupling that is included in the transceiver device and to an optical wire that is included in the cable and that is coupled to the transceiver device, the optical signal data.

15. (canceled)

16. The method of claim 14, wherein the transceiver device includes a cable coupling port that is connected to a cable connector included on the cable, wherein the cable coupling port is configured to attach and detach from the cable connector.

17. The method of claim 14, wherein the electrical wire coupling is configured to transmit the second portion of the power to the electrical wire in the cable that includes copper, and wherein the optical wire coupling is configured to transmit the optical signal data to the optical wire in the cable that includes a fiber optic wire.

18. (canceled)

19. The method of claim 14, wherein transceiver device transmits the optical signal data via the optical wire coupling and over the optical wire in the cable at data transmission speeds in excess of 100 Gigabits per second (Gbps).

20. The method of claim 14, wherein the electrical wire in the cable is free of twisted electrical wire pairs, and wherein the cable is free of ElectroMagnetic Interference (EMI) shielding.
